(19) United States
(12) Patent Application Publication
(10) Pub. No.: US 2013/0340606 A1
(43) Pub. Date: Dec. 26, 2013

(54) CONTINUOUSLY BLOCKABLE LOCKING DEVICE

(71) Applicants: Frank Born, Dienethal (DE); Frank Doffing, Kastellaun (DE); Thomas Klar, Bendorf (DE); Rolf Mintgen, Thuer (DE); Gerd Muelhoefer, Laubach (DE); Timo Schumacher, Weissenthurm (DE); Wilhelm Schwab, Koblenz (DE)

(72) Inventors: Frank Born, Dienethal (DE); Frank Doffing, Kastellaun (DE); Thomas Klar, Bendorf (DE); Rolf Mintgen, Thuer (DE); Gerd Muelhoefer, Laubach (DE); Timo Schumacher, Weissenthurm (DE); Wilhelm Schwab, Koblenz (DE)

(21) Appl. No.: 13/973,826

(22) Filed: Aug. 22, 2013

Related U.S. Application Data
(62) Division of application No. 12/473,960, filed on May 28, 2009.

(30) Foreign Application Priority Data
May 28, 2008 (DE) 10 2008 025 559.9
May 12, 2009 (DE) 10 2009 020 786.4

(51) Int. Cl. F15B 15/26

(52) U.S. Cl. CPC F15B 15/26
USPC 92/8

(57) ABSTRACT

A housing having a first housing end and a second housing end, a substantially cylindrical work chamber formed in the housing, a piston which is arranged in the work chamber so as to be displaceable and which divides the work chamber into a first work space near the first housing end and a second work space near the second housing end, a piston rod which is arranged at one side of the piston and which projects through the first work space and is guided out of the work chamber in a sealed manner at the first housing end through a guiding and sealing device, and a valve chamber which is formed in the housing parallel to the work chamber and in which a first valve assembly and a second valve assembly are arranged. The work chamber is always completely filled with a liquid medium and the valve chamber is at least partially filled with a liquid medium.

### CROSS REFERENCE TO RELATED APPLICATIONS

This application is a divisional of U.S. patent application Ser. No. 12/473,960 which was filed with the U.S. Patent and Trademark Office on May 28, 2009. Priority is claimed for this invention and application, corresponding applications having been filed in Germany on May 28, 2008, No. 10 2008 025 559.9 and in Germany on May 12, 2009, No. 10 2009 020 786.4, respectively.

### BACKGROUND OF THE INVENTION

1. Field of the Invention

The invention is directed to a continuously blockable locking device with a housing having a first end and a second end, a substantially cylindrical work chamber formed in the housing, a piston which is arranged in the work chamber so as to be displaceable and which divides the work chamber into a first work space near the first end and a second work space near the second end, a piston rod which is arranged at one side of the piston and which projects through the first work space and is guided out of the work chamber in a sealed manner at the first end through a guiding and sealing device, and a valve chamber formed in the housing parallel to the work chamber in which a first valve assembly and a second valve assembly are arranged.

2. Description of the Related Art

A locking device of the type mentioned above is known from DE 199 38 306 A1 in which the valve assemblies are arranged in overflow channels and outlet channels so that a relatively large installation space is needed.

### SUMMARY OF THE INVENTION

It is an object of the invention to provide an economical, continuously blockable locking device with a compact structural shape.

This object is met in that the continuously blockable locking device comprises a housing having a first housing end and a second housing end, a substantially cylindrical work chamber formed in the housing, a piston which is arranged in the work chamber so as to be displaceable and which divides the work chamber into a first work space near the first housing end and a second work space near the second housing end, a piston rod arranged at one side of the piston and which projects through the first work space and is guided out of the work chamber in a sealed manner at the first housing end through a guiding and sealing device, and a valve chamber which is formed in the housing parallel to the work chamber and in which a first valve assembly and a second valve assembly are arranged.

In another embodiment, the work chamber and valve chamber are separated from one another by an intermediate wall, wherein a first connection channel is constructed in the intermediate wall near the first housing end and a second connection channel is constructed in the intermediate wall near the second housing end, and the first connection channel and second connection channel connect the work chamber and the valve chamber.

In a particular embodiment, the valve chamber is filled mostly with the liquid medium and is filled with a gas under pressure.

In one embodiment, the liquid medium is a hydraulic oil and the gas is nitrogen.

In a further embodiment of the invention, a first valve assembly is arranged in the valve chamber near the first housing end and a second valve assembly is arranged in the valve chamber near the second housing end. Further, the two valve assemblies are preferably arranged at a distance from one another and a connection space is formed between the two valve assemblies.

In another embodiment, the first valve assembly comprises a force-loaded check valve whose closing member opens in the direction of flow from the first housing end to the connection space against the force of a helical compression spring during an outward movement of the piston rod and the resulting increase in pressure in the first work space, wherein the oil displaced by the piston flows into the connection space and then into the second work space via an unloaded check valve of the second valve assembly.

The second valve assembly likewise comprises a force-loaded check valve whose closing member opens in the direction of flow from the second housing end to the connection space against the force of a helical compression spring during an inward movement of the piston rod and the resulting increase in pressure in the second work space, wherein the oil displaced by the piston flows into the connection space and then into the first work space via an unloaded check valve of the first valve assembly.

The housing preferably has a closable opening at its upper side so that the oil and gas can be introduced or removed in a simple manner. In another embodiment of the invention, the force-loaded check valves and the unloaded check valves of the first valve assembly and of the second valve assembly are arranged in a material block, and every material block can be constructed as part of the housing.

In one embodiment, the valve chamber has an at least partially oval cross-sectional shape.

In a further embodiment of the invention, a fastening element is arranged at the first housing end of the housing and is welded or glued to the housing or is formed integral with the housing, and at least one bore hole for receiving a screw is formed in the fastening element.

In another embodiment, the fastening element is arranged at the housing so as to be swivelable.

Alternatively, a ball in which a screw can be screwed can be arranged in the at least one bore hole of the fastening element.

According to the invention, it is also possible to form the fastening element located at the first housing end as an articulated head by which the housing can be swivelably fastened to a structural component part, for example, the body of a vehicle.

In a further embodiment of the invention, the housing has a substantially L-shaped longitudinal section. The work chamber has a longer extension in axial direction than the valve chamber.

In another embodiment of the invention, a damping cup is arranged in the extension of the work chamber, and a damping sleeve arranged at the piston penetrates into this damping cup when the piston rod moves outward.

In another embodiment, the valve chamber has a cylindrical shape with a circular cross section.

In a further embodiment of the invention, a through-opening extends from the connection space and connects the valve chamber to another volume compensation chamber which is arranged above the valve chamber and which is filled with oil and a gas.

In an advantageous further embodiment of the invention, the two valve assemblies and their respective force-loaded and unloaded check valves are arranged in a tubular valve receiving body which can be inserted into the valve chamber.

In another embodiment, the valve receiving body has, at its ends, a closure wall that faces the first housing end and a closure wall which faces the second housing end, a first annular chamber located between the first housing end and the closure wall, and a second annular chamber located between the second housing end and the closure wall.

Further, the force-loaded check valve and the unloaded check valve are preferably arranged in the closure wall, and the force-loaded check valve and the unloaded check valve are arranged in the closure wall.

In another embodiment, a sealing device is provided at the respective ends of the valve receiving body.

In a preferred embodiment of the invention, sealing devices form the unloaded check valves.

In another embodiment, the housing is arranged at a fastening bracket. The fastening bracket preferably has a substantially U-shaped web whose first end is connected by a fastening pin to a knuckle eye arranged at the second housing end.

In another embodiment of the invention, a flange is formed at the second end of the web located opposite from the first end, and the flange has two projections, each with an internal thread, for fastening the bracket to a swivelable structural component part, in particular a vehicle door.

In a further embodiment, the flange is connected to a plate in which a cutout is provided through which the piston rod extends, and bellows which are connected to the piston rod near a connection element formed as a ball socket can be inserted into the cutout. Alternatively, the fastening bracket can be arranged at the area of the work chamber extending past the valve chamber.

In a further embodiment of the invention, the housing is fastened by two angled plates to the area of the work chamber extending past the valve chamber.

In order to make possible a compact construction with valve assemblies which are arranged closely adjacent to one another, first and second valve assemblies are preferably arranged parallel to one another and perpendicular to the cylindrical work chamber.

In a further embodiment, the connection space which directly connects the first and second valve assemblies to one another adjoins the end of the upwardly directed side of the two valve assemblies which is remote of the work chamber.

According to one embodiment of the invention, the valve chamber can be divided, at least partially, into a first partial chamber and a second partial chamber by means of a dividing wall, the first valve assembly being accommodated in the first partial chamber and the second valve assembly being accommodated in the second partial chamber, and the two partial chambers are connected to one another by the connection space.

In order to provide any desired length for the work chamber and, consequently, any lift length regardless of the structural size of the valve chamber, the connection channel is formed parallel to the work chamber and forms a fluidic connection between the second work space and the second valve assembly.

In another advantageous embodiment, at least one flow channel is provided in the cover closing the work chamber and/or a connection slot is provided between the second work space and the second connection channel which is guided parallel to the latter. In so doing, the first connection channel connects the first work space to the valve chamber by a receiving chamber.

It is particularly advantageous for a simple construction when a cover is arranged on the valve chamber, which cover closes the valve chamber so as to seal it relative to the outer environment and holds the first valve assembly and second valve assembly in their position, wherein the cover has, for every valve assembly, a holding web around which work medium flows and which brings the valve assemblies into contact with the wall of the work chamber.

In order to make the locking device even more versatile, an electrically controllable valve unit or a cover can be arranged at the receiving chamber.

Further, according to one embodiment of the invention, a sensor device is arranged at the pivot point of the housing at the fastening bracket, and the angle and/or angular velocity can be determined by means of this sensor device.

In an alternative embodiment of the invention, the dividing wall in the valve chamber is formed by two dividing walls forming a receiving space therebetween.

According to one embodiment of the invention, an electrically controllable valve unit or a filling body can be inserted into the receiving space. The filling body keeps two openings in the dividing walls closed, and the openings can be opened or closed by the valve unit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiment examples of the invention are shown in the drawings and are described more fully in the following.

FIGS. 1A and 1B are a longitudinal section and a cross section of a continuously blockable locking device according to the invention;

FIG. 2 is an arresting device 1 according to the invention with a fastening device;

FIG. 3 is a fastening device of the door arresting device shown in FIG. 2;

FIG. 4 is a fastening device of the door arresting device shown in FIG. 2;

FIG. 5 is a fastening device of the door arresting device shown in FIG. 2;

FIGS. 6A and 6B are a door arresting device according to one embodiment of the invention;

FIGS. 7A and 7B are a door arresting device shown in FIG. 5;

FIG. 8 is a fastening device for the door arresting device shown in FIG. 5;

FIG. 9 is a fastening device of the door arresting device shown in FIG. 5;

FIG. 10 is a fastening device of the door arresting device shown in FIG. 5;

FIG. 11 is a door arresting device according to one embodiment of the invention;

FIG. 12 is a locking device according to the invention;

FIG. 13 is a door arresting device according to the invention; and

FIG. 14 is a door arresting device according to the invention.

### DETAILED DESCRIPTION OF THE PRESENTLY PREFERRED EMBODIMENTS

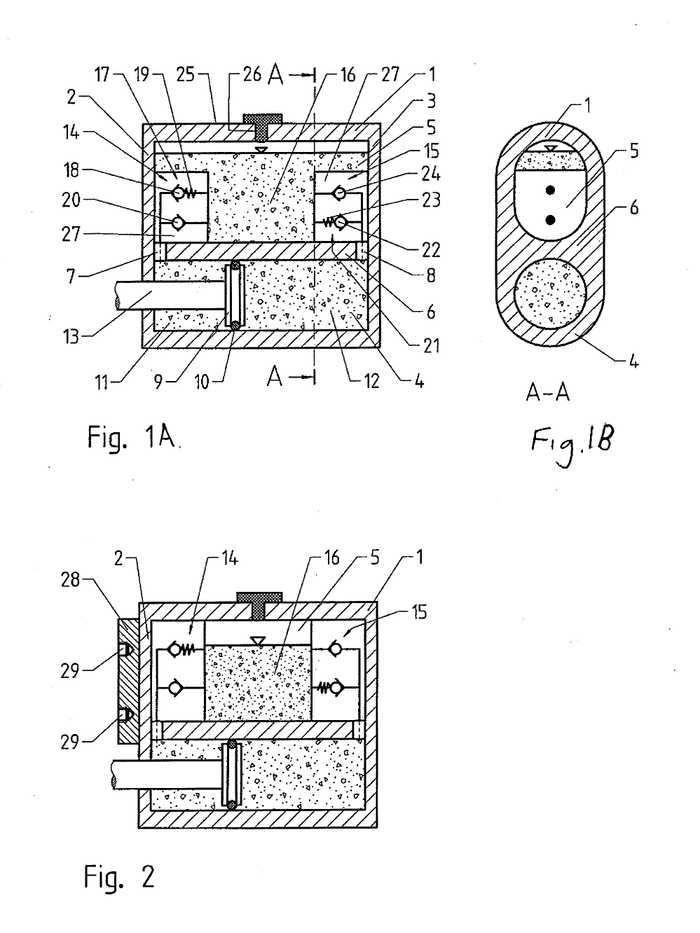

FIGS. 1A and 1B show a continuously blockable locking device for doors or hatches of motor vehicles having a housing 1 which has a first end wall, designated as first housing end 2, and a second end wall, designated as second housing end 3. A substantially cylindrical work chamber 4 and a valve chamber 5 which is arranged parallel to the work chamber 4 and which has a substantially oval cross section are formed in the housing 1. The work chamber 4 and the valve chamber 5 are separated from one another by an intermediate wall 6. A first connection channel 7 is formed in the intermediate wall 6 near the first housing end 2 and a second connection channel 8 which connects the work chamber 4 to the valve chamber 5 is formed in the intermediate wall 6 near the second housing end 3.

The work chamber 4 is preferably always completely filled with a liquid medium, preferably hydraulic oil. The valve chamber 5 is filled with hydraulic oil for the most part and to a small extent with a gas, preferably nitrogen, which is under pressure. The valve chamber 5 can accordingly compensate for variations in the temperature of the oil and the volume of oil displaced by the piston rod when it moves into the work chamber 4. Further, the valve chamber 5 is designed in such a way that the valves are always immersed in oil even when the locking device is sharply inclined.

Arranged in the work chamber 4 so as to be axially displaceable is a piston 9 having a piston ring 10 which divides the work chamber 4 into a first work space 11 adjoining the first housing end 2 and a second work space 12 adjoining the second housing end 3 in such a way that the oil cannot overflow from one work space into the other by way of the piston 9. However, a possibility for overflow can be provided in the form of one or more axial grooves, not shown, at the inner wall of the work chamber 4 to create an area in which the door arresting device cannot be blocked.

The piston 9 is connected to a piston rod 13 which extends in axial direction of the housing 1 through the first work space 11 and is guided out of the first housing end 2 by way of a sealing and guiding device, not shown, such as those constructed in gas springs or dampers.

A first valve assembly 14 is arranged in the valve chamber 5 near the first housing end 2 and a second valve assembly 15 is arranged in the valve chamber 5 near the second housing end 3. The two valve assemblies are arranged at a distance from one another and a connection space 16 is formed between the two valve assemblies.

The first valve assembly 14 comprises a force-loaded check valve 17 whose closing member 18 opens in the direction of flow from the first housing end 2 to the connection space 16 against the force of a helical compression spring 19 when the piston rod 13 moves outward and the pressure in the first work space 11 is accordingly increased. In this way, the fluid displaced by the piston 9 flows into the connection space 16 and then into the second work space 12 via an unloaded check valve 24 of the second valve assembly 15.

In a corresponding manner, the second valve assembly 15 comprises a force-loaded check valve 21 whose closing member 22 opens in the direction of flow from the second housing end 3 to the connection space 16 against the force of a helical compression spring 23 during the inward movement of the piston rod 13 and the resulting increase in pressure in the second work space 12.

The liquid medium displaced by the piston 9 can flow into the connection space 16 and then into the first work space 11 via an unloaded check valve 20 of the first valve assembly 14.

When the piston rod 13 is not loaded, all of the valves are closed and the piston 9 is held in its instantaneous position.

The housing 1 preferably has a closeable opening 26 at its upper side 25 by which the oil and gas can be introduced or removed.

The force-loaded check valves and the unloaded check valves of the first valve assembly 14 and of the second valve assembly 15 are arranged in a material block 27. Every material block is part of the housing 1.

FIG. 2 shows another embodiment form of the door arresting device according to the invention. The first valve assembly 14 and the second valve assembly 15 completely fill the oval cross section of the valve chamber 5, but again define the connection space 16 which is filled mostly with oil and to a small extent with a gas under pressure, preferably nitrogen, so that a temperature compensation and/or volume compensation is again possible.

A fastening element 28 is arranged at the first housing end 2 of the housing 1 and is welded or glued to the housing 1 or is formed integral with the housing 1. At least one bore hole 29 in which a screw, not shown, can be screwed is provided in the fastening element 28 for connecting the housing 1, for example, to the door of a motor vehicle.

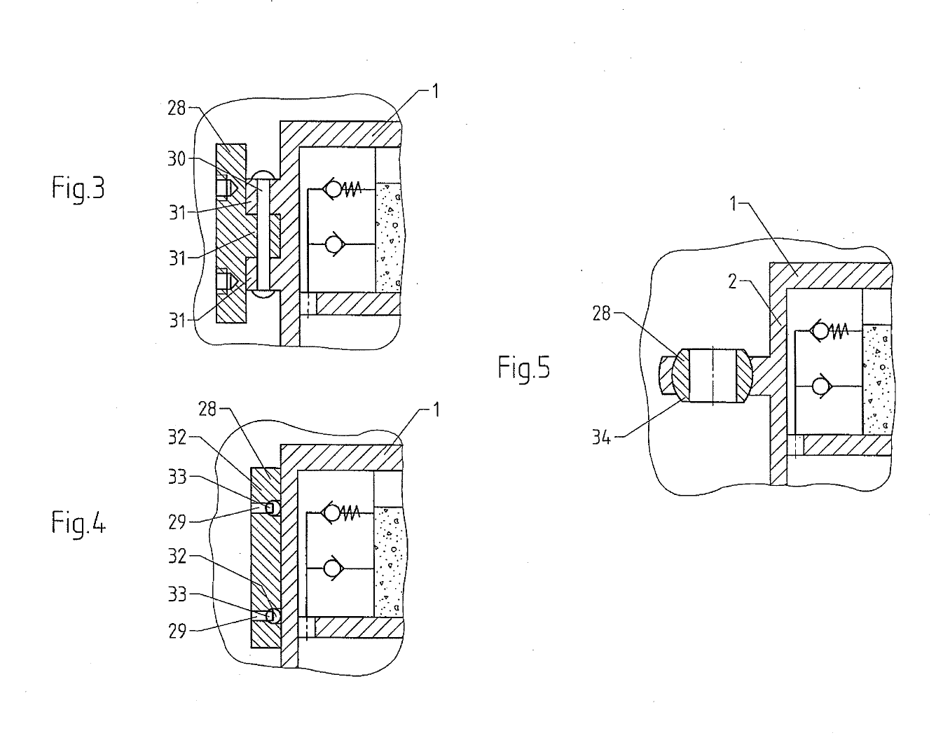

FIG. 3 shows fastening element 28 is arranged at the housing 1 so as to be swivelable by means of a pin 30 and several projections 31 at the fastening element 28 and the first housing end 2, which projections 31 can be penetrated by the pin 30.

As shown in FIG. 4, a ball 32 with a pocket hole 33 in which a screw, not shown, can be screwed is arranged in the at least one bore hole 29 of the fastening element 28 to connect the housing 1 to a structural component part, for example, a vehicle door, so as to be swivelable.

In FIG. 5, the fastening element 28 is formed at the first housing end 2 as an articulated head 34 by which the housing 1 can be swivelably fastened to a structural component part of a motor vehicle, for example, the door.

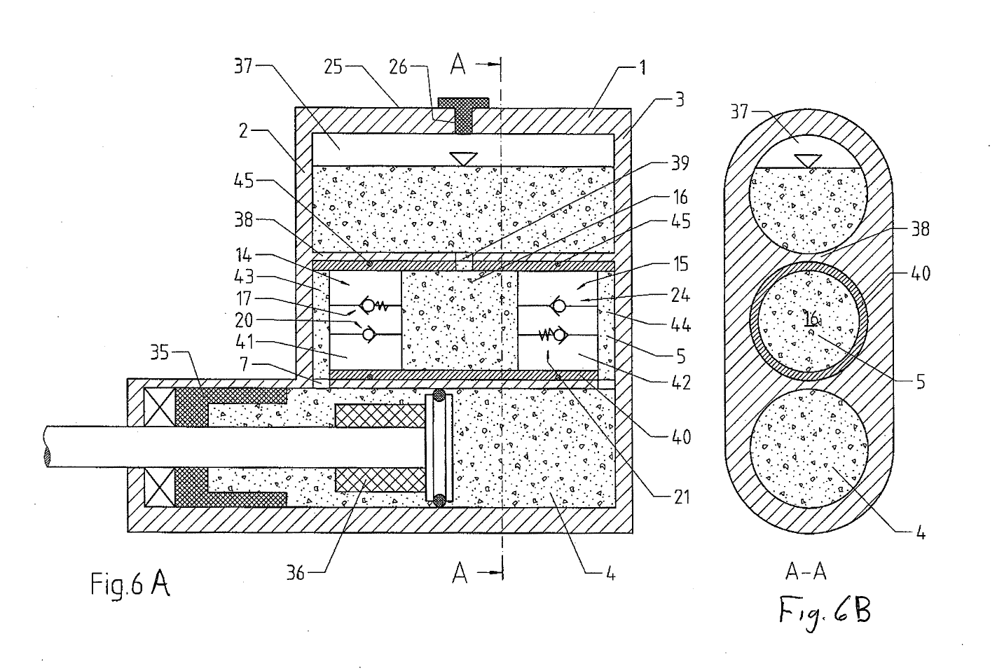

As shown in FIGS. 6A and 6B, the housing 1 has a substantially L-shaped cross section because the work chamber 4 has a longer extension in axial direction than the valve chamber 5. A damping cup 35, shown schematically, is arranged in the extension of the work chamber 4. A damping sleeve 36 arranged at the piston 9 can penetrate into this damping cup 35 when the piston rod 13 moves outward. The axial length of the damping sleeve 36 is selected in such a way that the piston ring 10 of the piston 9 cannot move over the first connection channel 7 when the damping sleeve 36 strikes the base of the damping cup 35.

The damping device formed by the damping cup 35 and damping sleeve 36 prevents the vehicle door from being moved too quickly against its end stop and possibly swinging back again when the vehicle door is opened to the full extent.

In this embodiment form, the valve chamber 5 preferably has a cylindrical shape with a circular cross section. The two valve assemblies 14 and 15 are completely immersed in oil and limit the connection space 16 in axial direction, which connection space 16 is preferably completely filled with oil. A volume compensation chamber 37 is arranged parallel to the valve chamber 5 and is separated by an intermediate wall 38 from the valve chamber 5. A through-opening 39 which joins the valve chamber 5 to the volume compensation chamber 37 extends from the connection space 16 through the intermediate wall 38. The volume compensation chamber 37 is filled with oil and a gas. The closable opening 26 through which the interior of the housing 1 can be filled with oil and gas via the volume compensation chamber 37 is provided at the upper side 25 of the housing 1.

The two valve assemblies 14 and 15 and their respective force-loaded check valves and unloaded check valves are arranged in a tubular valve receiving body 40 which is located in a preferably preassembled state in the valve chamber 5. The valve receiving body 40 has, at its ends, a closure wall 41 which faces the first housing end 2 and a closure wall 42 which faces the second housing end 3. A first annular chamber 43 is located between the first housing end 2 and the closure wall 41, and a second annular chamber 44 is located between the second housing end 3 and the closure wall 42. The force-loaded check valve 17 and the unloaded check valve 20 are arranged in the closure wall 41. The force-loaded check valve 21 and the unloaded check valve 24 are arranged in the closure wall 42. The connection space 16 is located between the two closure walls. A sealing device 45 is provided at the ends of the valve receiving body 40 so that the oil can only flow via the valves from the connection space 16 into one of the annular chambers 43, 44, or vice versa.

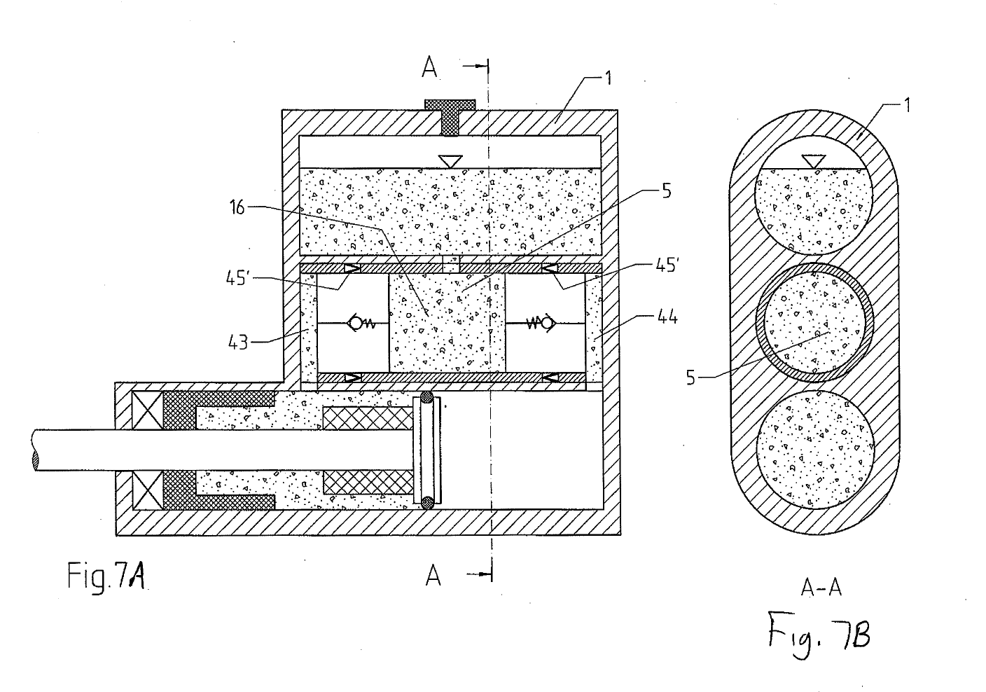

As is shown in FIGS. 7A and 7B, the unloaded check valves are formed by the two sealing devices 45′. The sealing devices 45′ have a substantially V-shaped cross section or the shape of piston rod seals such as are known, for example, in gas springs or dampers. The preferable V-shaped cross section ensures that the oil can flow from the connection space 16 into the annular chambers 43 or 44 in that the pressure of the oil presses around the sealing lip contacting the inner wall of the valve chamber 5. If the pressure in the annular chambers 43 or 44 increases, the sealing lip is pressed more firmly against the inner wall of the valve chamber 5 and prevents the flow of oil into the connection space 16 through the sealing devices 45′.

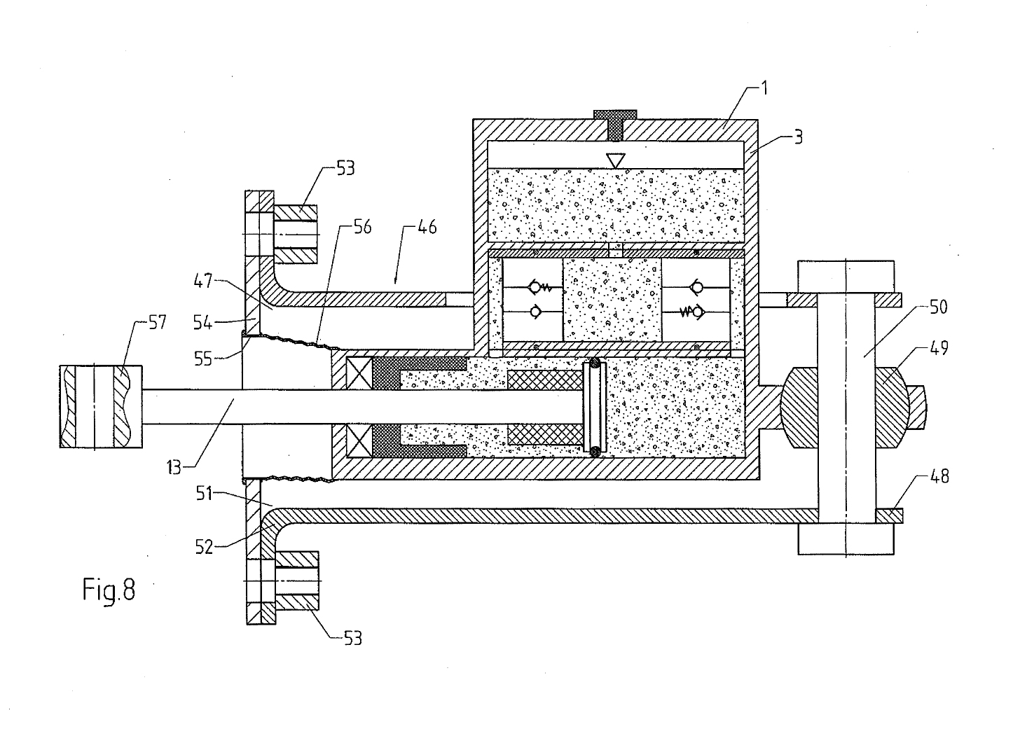

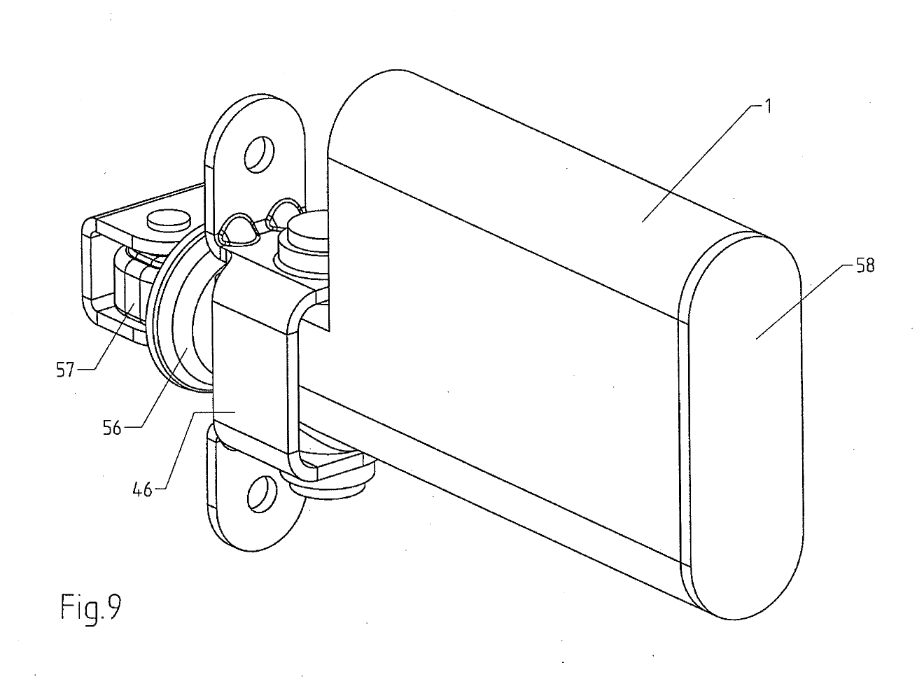

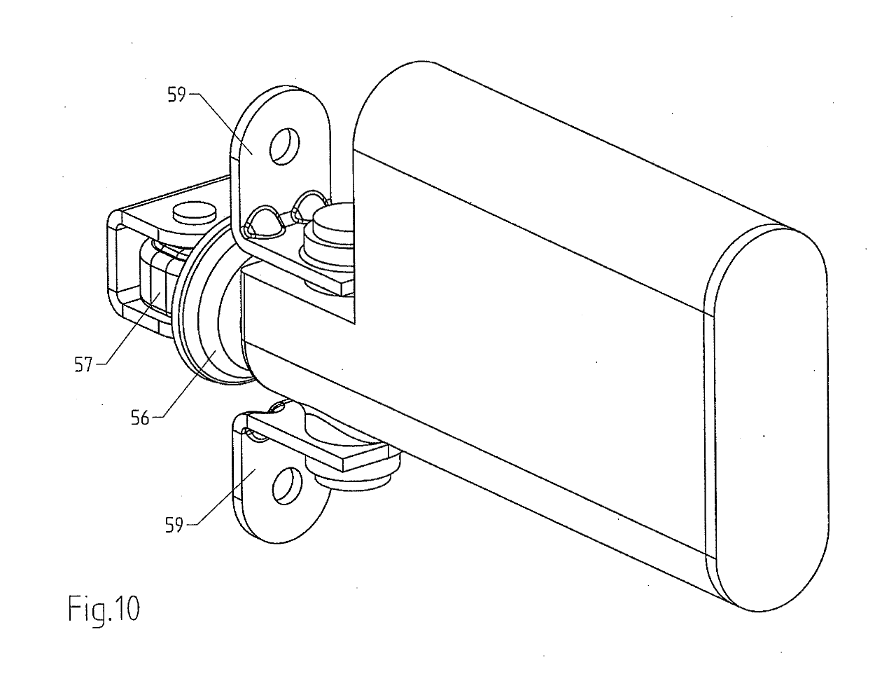

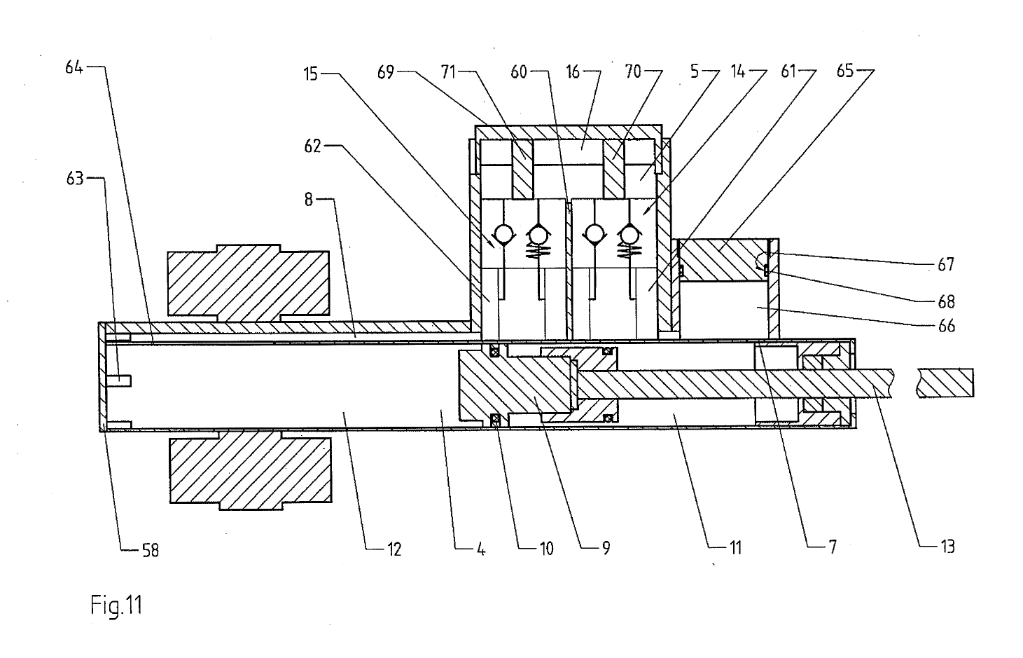

FIG. 8 shows the embodiment example of the door arresting device shown in FIG. 6 with a fastening bracket 46. The fastening bracket 46 has a substantially U-shaped web 47 whose first end 48 is connected to a knuckle eye 49 arranged at the second housing end 3 so as to be swivelable by means of a fastening pin 50. A flange 52 is formed at a second end 51 of the web 47 located opposite from the first end 48. The flange 52 has two projections 53, each having an internal thread by means of which the fastening bracket 46 can be fastened to a structural component part, for example, a vehicle door. The flange 52 is connected to a plate 54 in which is provided a cutout 55 through which the piston rod 13 extends. Bellows 56 which are connected to the housing 1 or to the piston rod 13 near a connection element 57, as shown in FIGS. 9 and 10, is preferably inserted into the cutout 55.

As shown in FIG. 9, the fastening bracket 46 is fastened at the area of the work chamber 4 extending past the valve chamber 5. The axial extension of the fastening bracket 46 is also substantially limited to this area. Further, it can be seen that the second housing end 3 of the housing 1 can also be formed by a cover 58 which is welded or glued to the housing.

As shown in FIG. 10, the door arresting device is fastened by means of two angled plates 59 which are fastened to the area of the work chamber 4 extending past the valve chamber 5.

The door arresting devices shown in the drawings are preferably made of plastic but can also be made of, e.g., aluminum, steel, or an alloy of a wide variety of metals, which makes it possible to achieve a reduction in weight. Further, the housing can comprise two halves which are connected to one another or can comprise a main body which is closed by at least one cover 58 which forms the first and/or second housing end 2, 3. Further, the constructions described above, for example, with respect to the valve assembles 14, 15, the fastening bracket 46, the fastening element 28 or the like, can, of course, also apply to the embodiment forms described in the following.

As shown in FIGS. 11 to 14, first and second valve assembles 14, 15 are not constructed in a common center axis but are substantially parallel to one another and substantially perpendicular to the cylindrical work chamber 4. The connection space 16 which directly connects the first and second valve assemblies 14, 15 to one another adjoins the end of the upwardly directed side of the two valve assemblies which is remote of the work chamber 4. The connection space 16 is partly filled with gas to compensate for the volume displaced by the inward and outward movement of the piston rod 13 of the door adjustment system and for the thermal expansion of the liquid work medium.

In order to realize a compact construction with valve assemblies 14 and 15 arranged closely adjacent to one another for both directions, the valve chamber 5 is divided at least partially into a first partial chamber 61 and a second partial chamber 62 by means of a dividing wall 60. The first valve assembly 14 is accommodated in the first partial chamber 61, and the second valve assembly 15 is accommodated in the second partial chamber 62. The two partial chambers 61, 62 are connected to one another by the connection space 16. Further, a flow guide is provided which provides the connection channel 8 parallel to the work chamber 4 and forms a fluidic connection between the second work space 12 and the second partial chamber 62 of the valve chamber 5 and, therefore, the second valve assembly 15. An advantage of this embodiment form consists in that any length of the work chamber 4 and, consequently, any lift length can be provided regardless of the structural size of the valve chamber 5. In addition, flow channels 63 can also be provided in the cover 58 closing the work chamber 4. In a suitable embodiment form, a connection slot 64 can be used between the second work chamber 12 and the second connection channel 8 which is guided parallel to the latter so that there is a flow around the piston ring 10 of the piston 9 and, in this way, an area is provided which is free of locking forces.

The first connection channel 7 connects the first work space 11 to the first partial chamber 61 of the valve chamber 5 by a receiving chamber 66 which is closed by a cover 65. As is shown in the drawing, the cover 65 can be provided with an annular groove 67 into which a sealing ring 68 is inserted to seal the receiving chamber 66 from the outer environment.

A cover 69 is likewise arranged on the valve chamber 5 and closes the valve chamber 5 so as to seal it from the outer environment. Further, the cover 69 serves to hold the first valve assembly 14 and second valve assembly 15 in their position. For this purpose, the cover 69 for every valve assembly has a holding web 70 and 71, respectively, around which work medium flows and which brings the valve assemblies into contact with the wall of the work chamber 4.

It should be noted that the receiving chamber 66 and the valve chamber 5 are preferably constructed closer to the first end 2 of the housing 1 similar to FIGS. 1 to 5.

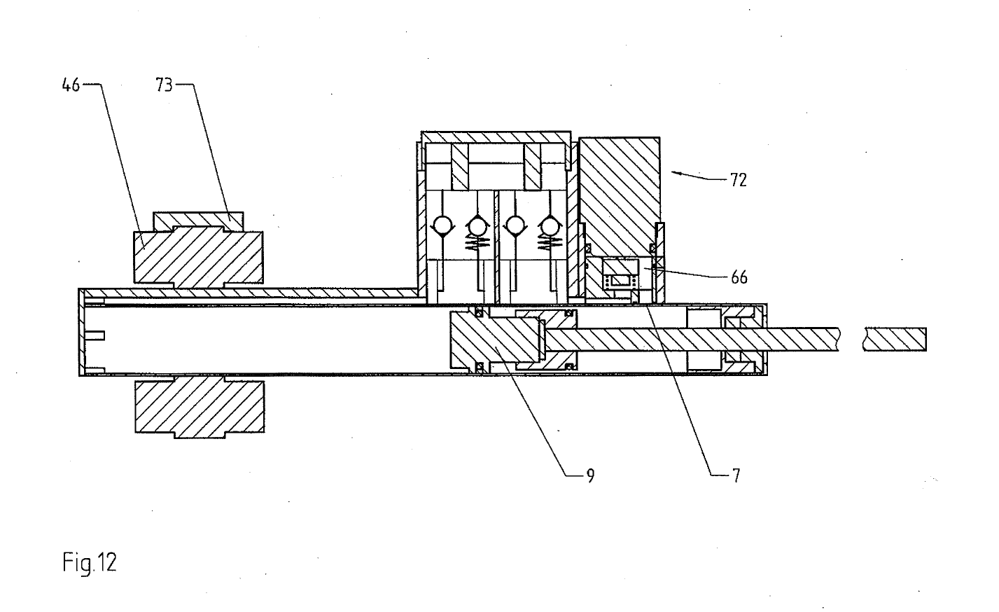

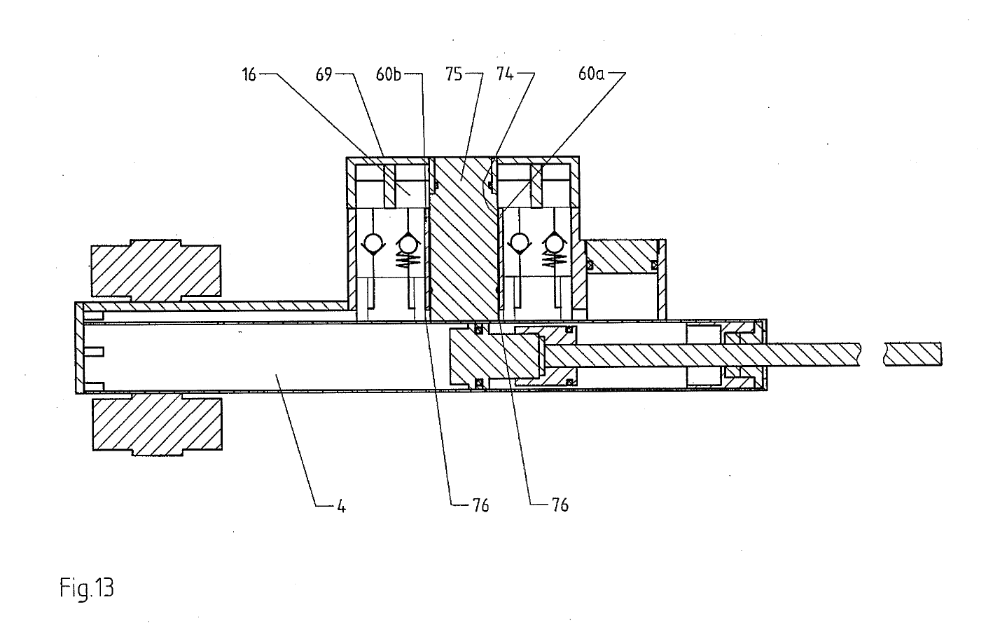

As can be seen from FIG. 12, the cover 65 from FIG. 11 can be omitted and an electrically controllable valve unit 72, shown schematically, can be arranged in place of the cover 65 at the receiving chamber 66. In addition, a sensor device 73 is arranged at the pivot point of the housing 1 at the fastening bracket 46 which is shown schematically. The angle and/or angular velocity can be determined by means of this sensor device 73. In cooperation with a device, not shown, for detecting obstacles, for example, a camera, a capacitive sensor, or the like, the valve unit 72, which is preferably constructed as a proportional valve, can close the first connection channel 7, preferably to an increasing extent as the door approaches the obstacle. However, it is also possible that the valve can be closed abruptly. By closing the connection channel 7, the flow of medium is blocked in the entire system and the piston 9 is accordingly rigidly locked. The door cannot be moved any farther.

FIG. 13 substantially corresponds to the locking device shown in FIG. 11, but the dividing wall 60 in the valve chamber 5 is formed by two dividing walls 60a and 60b which form a receiving space 74 therebetween in which a cylindrical filling body 75 is arranged. Near the work chamber 4, the dividing walls 60a and 60b have openings 76 which open into the receiving space 74, but which are closed by the filling body 75 so as to be tight against fluid. The working medium flows around the part of the filling body 75 that is close to the cover 69, that is, the part of the filling body 75 located in the connection space 16. In other respects, the operation of the locking device corresponds exactly to that of the embodiment form shown in FIG. 11.

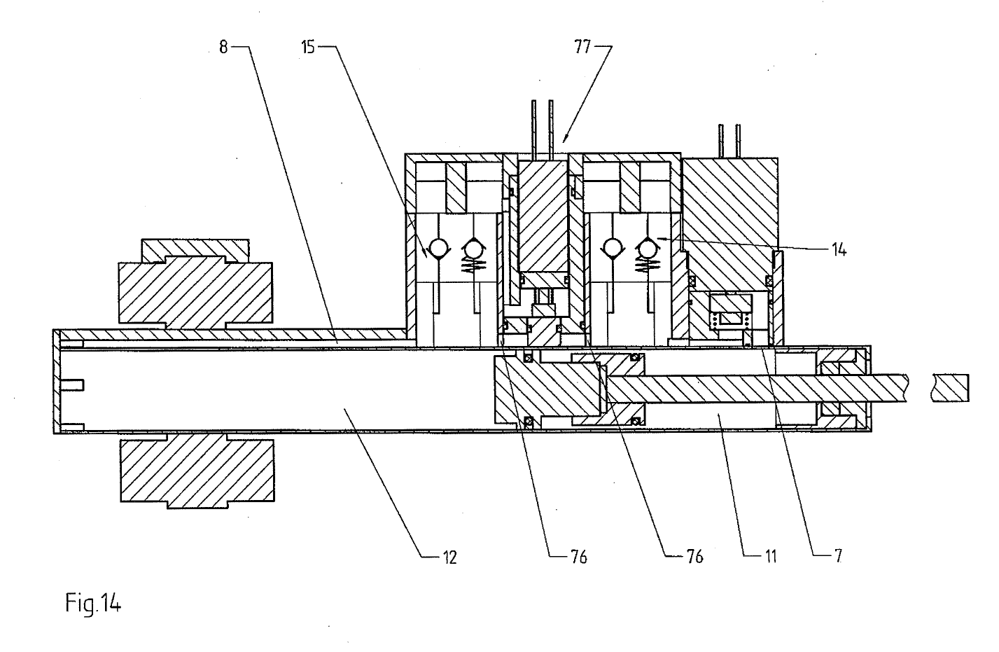

FIG. 14 shows the door arresting device from FIG. 13 in which the filling body 75 from FIG. 13 has been replaced by another electrically controllable valve unit 77 which is also shown schematically. By means of the valve unit 77, the first valve assembly 14 and the second valve assembly 15 can be short-circuited by releasing the openings 76, and the work medium can flow directly through the connection channels 7 and 8 from one of the work spaces 11 or 12 into the other work space. Accordingly, the medium no longer flows through the valve assemblies 14 and 15 because of their high flow resistance which comprises the blocking force of the entire system. In this way, the door can be moved very easily in the closing direction and in the opening direction. The valve of the valve unit 77 can preferably be opened when, for example, a user's hand is sensed at a door handle, not shown.

It is clear from the embodiment forms shown in FIGS. 11 to 14 that various functions can also be provided subsequently when the locking device is already installed, namely, in addition to the simple locking function, an obstacle function can be provided through the installation of the valve unit 72 and a convenience function can be provided through the installation of the valve unit 77, or both additional functions can be provided at the same time.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A continuously blockable locking device comprising:
a housing having a first end and a second end opposite the first end;
a substantially cylindrical work chamber formed in the housing that is always completely filled with a liquid medium;
a piston displaceably arranged in the work chamber, the piston dividing the work chamber into a first work space proximate to the first end and a second work space proximate to the second housing end;
a piston rod arranged at one side of the piston, the piston rod projecting through the first work space and is sealedly guided out of the work chamber at the first end through a guiding and sealing device; and
a valve chamber formed in the housing, the valve chamber being substantially parallel to and directly fluidically connected to the work chamber, the valve chamber comprising:
a first valve assembly; and
a second valve assembly,
wherein the valve chamber is at least partially filled with the liquid medium,
whereby a blocking of a flow of the liquid medium locks the piston.

2. The continuously blockable locking device according to claim 1, further comprising:
an intermediate wall extending from the first end to the second end separating the work chamber and the valve chamber;
a first connection channel in the intermediate wall near the first housing end; and
a second connection channel is constructed in the intermediate wall near the second housing end,
wherein the first connection channel and the second connection channel are configured to couple the work chamber and the valve chamber.

3. The continuously blockable locking device according to claim 1, wherein the valve chamber is filled mostly with the liquid medium and is filled to a smaller extent with a gas under pressure.

4. The continuously blockable locking device according to claim 3, wherein the liquid medium is hydraulic oil and the gas is nitrogen.

5. The continuously blockable locking device according to claim 1, wherein the first valve assembly is arranged in the valve chamber near the first end and the second valve assembly is arranged in the valve chamber near the second end.

6. The continuously blockable locking device according to claim 5, wherein the two valve assemblies are arranged at a distance from one another and a connection space is formed between the two valve assemblies.

7. The continuously blockable locking device according to claim 6, wherein the first valve assembly comprises a force-loaded check valve having a closing member configured to open in a direction of flow from the first housing end to the connection space against the force of a helical compression spring during an outward movement of the piston rod causing an increase in pressure in the first work space, wherein the oil displaced by the piston flows into the connection space and then into the second work space via an unloaded check valve of the second valve assembly.

8. The continuously blockable locking device according to claim 7, wherein the second valve assembly comprises a force-loaded check valve having a closing member configured to open in the direction of flow from the second housing end to the connection space against the force of a helical compression spring during an inward movement of the piston rod and the resulting increase in pressure in the second work space, wherein the oil displaced by the piston flows into the connection space and then into the first work space via an unloaded check valve of the first valve assembly.

9. The continuously blockable locking device according to claim 1, wherein the housing has a closable opening so that the oil and gas can be introduced or removed.

10. The continuously blockable locking device according to claim 6, wherein force-loaded check valves and unloaded check valves of the first valve assembly and of the second valve assembly are arranged, respectively, in a material block, the material block being constructed as part of the housing.

11. The continuously blockable locking device according to claim 1, wherein the valve chamber has an at least partially oval cross-sectional shape.

12. The continuously blockable locking device according to claim 1, wherein a fastening element is arranged at the first housing end of the housing and is one of welded to the housing, glued to the housing, or is integrally formed with the housing, wherein at least one bore hole configured to receive a screw is formed in the fastening element.

13. The continuously blockable locking device according to claim 12, wherein the fastening element is swivelably arranged at the housing.

14. The continuously blockable locking device according to claim 12, wherein a ball in which a screw can be screwed is arranged in the at least one borehole of the fastening element.

15. The continuously blockable locking device according to claim 12, wherein the fastening element is an articulated head.

16. The continuously blockable locking device according to claim 1, wherein the housing has a substantially L-shaped longitudinal section.

17. The continuously blockable locking device according to claim 16, wherein the work chamber has a longer extension in axial direction than the valve chamber.

18. The continuously blockable locking device according to claim 17, further comprising:
a damping cup arranged in the extension of the work chamber; and
a damping sleeve arranged at the piston configured to penetrate into the damping cup when the piston rod moves outward.

19. The continuously blockable locking device according to claim 18, wherein the valve chamber has a cylindrical shape with a circular cross section.

20. The continuously blockable locking device according to claim 16, further comprising:
another volume compensation chamber arranged parallel to the valve chamber,
wherein a through-opening extends from the connection space and connects the valve chamber to the another volume compensation chamber that is filled with oil and a gas.

21. The continuously blockable locking device according to claims 1, wherein the two valve assemblies having respective force-loaded and unloaded check valves arranged in a tubular valve receiving body configured to be inserted into the valve chamber.

22. The continuously blockable locking device according to claim 21, wherein the valve receiving body further comprises:
a first closure wall that faces the first housing end; and
a second closure wall that faces the second housing end,
wherein a first annular chamber is located between the first housing end and the first closure wall and a second annular chamber is located between the second housing end and the second closure wall.

23. The continuously blockable locking device according to claim 22, wherein the force-loaded check valves and the unloaded check valves are arranged in each of the first and second the closure walls.

24. The continuously blockable locking device according to claim 23, wherein a sealing device is provided at ends of the valve receiving body.

25. The continuously blockable locking device according to claim 24, wherein the sealing device forms the unloaded check valves.

26. The continuously blockable locking device according to claims 1 to wherein the housing is arranged at a fastening bracket.

27. The continuously blockable locking device according to claim 26, wherein the fastening bracket comprises a substantially-U-shaped web having a first end connected by a fastening pin to a knuckle eye arranged at the second housing end.

28. The continuously blockable locking device according to claim 27, wherein a flange is formed at a second end of the web located opposite the first end, the flange having two projections, each projection having an internal thread configured for fastening the bracket to a swivelable structural component part.

29. The continuously blockable locking device according to claim 28, wherein the flange is connected to a plate in which a cutout is provided through which the piston rod extends, wherein a bellows connected to the piston rod is inserted into the cutout.

30. The continuously blockable locking device according to claim 26, wherein the fastening bracket is arranged at the area of the work chamber extending past the valve chamber.

31. The continuously blockable locking device according to claim 30, wherein the housing is fastened by two angled plates to the area of the work chamber extending past the valve chamber.

32. The continuously blockable locking device according to claim 1, wherein the first and second valve assemblies are arranged parallel to one another and perpendicular to the cylindrical work chamber.

33. The continuously blockable locking device according to claim 32, wherein a connection space connects the first and second valve assemblies with one another and adjoins an end of respective upwardly directed sides of the two valve assemblies that are remote of the work chamber.

34. The continuously blockable locking device according to claim 33, wherein the valve chamber is divided at least partially into a first partial chamber and a second partial chamber by a dividing wall, wherein the first valve assembly is accommodated in the first partial chamber and the second valve assembly is accommodated in the second partial chamber, the two partial chambers are connected to one another by the connection space.

35. The continuously blockable locking device according to claim 32, wherein a second connection channel is formed parallel to the work chamber and is configured to provide a fluidic connection between the second work space and the second valve assembly.

36. The continuously blockable locking device according to claim 35, wherein at least one of a flow channel is provided in a cover closing the work chamber and a connection slot is provided between the second work space and a second connection channel.

37. The continuously blockable locking device according to claim 32, wherein a first connection channel connects the first work space to the valve chamber by a receiving chamber.

38. The continuously blockable locking device according to claim 32, wherein a cover is arranged on the valve chamber, the cover closes the valve chamber to seal it from an outer environment and holds the first valve assembly and second valve assembly in their respective positions, wherein the cover has, for each valve assembly, a holding web around which work medium flows and which brings the valve assemblies into contact with the wall of the work chamber.

39. The continuously blockable locking device according to claim 37, wherein at least one of an electrically controllable valve unit and a cover are arranged at the receiving chamber.

40. The continuously blockable locking device according to claim 32, wherein a sensor device is arranged at the pivot point of the housing at the fastening bracket, the sensor device configured to measure at least one of an angle and angular velocity.

41. The continuously blockable locking device according to claim 34, wherein the dividing wall in the valve chamber comprises two separate dividing walls forming a receiving space therebetween.

42. The continuously blockable locking device according to claim 41, wherein at least one of an electrically controllable valve unit and a filling body are inserted into the receiving space, wherein the filling body keeps two openings in the dividing walls closed, and the openings can be opened or closed by the valve unit.
